(19) United States
(12) Patent Application Publication
(10) Pub. No.: US 2025/0363591 A1
(43) Pub. Date: Nov. 27, 2025

(54) HIGH RESOLUTION PATCH MANAGEMENT SYSTEM IN AN EARLY-STAGE IMAGE

(71) Applicants: Rony Zatzarinni, Tel Aviv (IL); Chaim Gross, Jerusalem (IL); Dor Barber, Herzliya (IL); Hava Matichin, Petah Tikva (IL); Moran Klein, Ra’anana (IL)

(72) Inventors: Rony Zatzarinni, Tel Aviv (IL); Chaim Gross, Jerusalem (IL); Dor Barber, Herzliya (IL); Hava Matichin, Petah Tikva (IL); Moran Klein, Ra’anana (IL)

(21) Appl. No.: 19/293,853

(22) Filed: Aug. 7, 2025

(51) Int. Cl. G06T 3/4046; G06T 3/4053; G06T 5/60; G06T 7/174; G06T 7/40

(52) U.S. Cl. CPC G06T 3/4046; G06T 3/4053; G06T 5/60; G06T 7/174; G06T 7/40; G06T 2207/20084

(57) ABSTRACT

Systems and methods for a patch management system that combines the benefits of working on a low-resolution image with added cues from the high-resolution image. The patch management system collects high-resolution patches during the downscaling process. The high-resolution patches are analyzed using a Deep Neural Network to detect fine details that are lost in the downscaled image. By fusing the high-resolution patch-level information with semantic segmentation results, the ISP blocks are provided with both global context and local details, improving texture reproduction and temporal noise reduction while adding minimal overhead compared to standard downscaled processing. The patch management system can also be used for tasks such as optical flow calculation from a downscaled image. By strategically selecting image areas for high-resolution patches, the system minimizes computational overhead as compared to processing a full-resolution image. The patch management system offers a cost-effective solution for devices that have limited processing power.

### TECHNICAL FIELD

This disclosure relates generally to image processing, and in particular to semantic texture prediction for enhanced image restoration.

### BACKGROUND

An Image Signal Processor (ISP) transforms raw sensor data into high-quality images using techniques such as denoising, sharpening, and demosaicing. To maintain low computational complexity, the image signal processing techniques are performed on a limited receptive field. However, the limited receptive field can result in inconsistent and inaccurate processing within an image frame. Better results are achieved when a full resolution image with sufficient receptive fields is used for image signal processing, but processing the full resolution image is computationally expensive and can result in frame delays.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1A is a block diagram of a patch management system, in accordance with various embodiments.

FIG. 1B is a block diagram of an early stage analysis pipeline, in accordance with various embodiments.

FIG. 2 is a block diagram of an ISP pre-processing pipeline including a downscaling pre-processing pipeline and a patch collection pipeline, in accordance with various embodiments.

FIG. 3 is a block diagram illustrating patch selection for texture analysis, in accordance with various embodiments.

FIG. 4 is a block diagram illustrating patch selection for change detection, in accordance with various embodiments.

FIG. 5 illustrates an example of an image processed with and without a patch collector and a patch processing module, in accordance with various embodiments.

FIG. 6 is a block diagram illustrating image processing including a patch processing module, in accordance with various embodiments.

FIG. 7 is a block diagram of a patch processing module implemented as deep neural network, in accordance with various embodiments.

FIG. 8 is a flowchart showing a method for patch processing, in accordance with various embodiments.

FIG. 9 is a block diagram of an example Deep Neural Network (DNN) system, in accordance with various embodiments.

FIG. 10 illustrates an example DNN, in accordance with various embodiments.

FIG. 11 is a block diagram of an example computing device, in accordance with various embodiments.

### DETAILED DESCRIPTION

### Overview

ISPs often employ early-stage image analysis to ensure consistent processing across an entire image frame. Early stage image analysis includes downscaling and analyzing the input image. The early-stage analysis, benefiting from a high receptive field, helps guide the ISP blocks, which operate with a limited receptive field, to make consistent processing decisions. An example of early-stage analysis is semantic segmentation, which allows the ISP to apply targeted processing configurations for different semantic objects. For example, the system suppresses sharpening in sky regions and applies minimal temporal noise reduction to human face regions to prevent blurriness and “ghost” artifacts during facial movements and/or head movements.

However, because the ISP performs the early analysis process on a low-resolution image, it lacks fine image details, which are lost during the downscaling process. The fine image details can be important in semantic segmentation and other early-stage image analysis. In particular, semantic segmentation utilizes segmentation and general knowledge about the semantics of the various portions of the image to guide the ISP blocks' decisions. For example, the “sky” semantic label is used as a proxy for flat regions where sharpening power will be decreased, but general knowledge about semantics can be insufficient for accurate segmentation. For example, when processing artificial scenes, such as a stage backdrop with a textured sky, analysis of a low-resolution image can lead to inaccurate semantic segmentation and image quality degradation. Similarly, the temporal noise reduction block determines whether objects are moving or static, and small movements can disappear in the downscaled low-resolution image. Thus, a temporal noise reduction block uses the “face” semantic label as a proxy for a moving object. However, in cases where human-like static dolls or pictures of faces are present in the scene, the “face” semantic label is not accurate, since the static dolls and pictures are not moving objects. Another example where semantics are not sufficient is when processing the “cloth” semantic label with the sharpening ISP block. The sharpening block's decision-making distinguishes cloth with high texture regions from smooth cloth region, but the fine details are lost in the downscaled image.

Thus, while downscaling enables efficient scene analysis, it results in inaccuracies since the downscaled image (and video stream) lacks low-level information about textures and subtle motions. The low-level information about textures and subtle motions is utilized for accurate optical flow computation. In particular, the detailed information is used to achieve optimal image quality at the ISP hardware blocks.

Systems and methods are presented herein for a patch management system that combines the benefits of working on a low-resolution image with added cues from the high-resolution image. The patch management system collects high-resolution patches during the downscaling process. The high-resolution patches are analyzed using a Deep Neural Network (DNN) to detect fine details that are lost in the downscaled image. By fusing the high-resolution patch-level information with semantic segmentation results, the ISP blocks are provided with both global context and local details, improving texture reproduction and temporal noise reduction while adding minimal overhead compared to standard downscaled processing. The patch management system can also be used for other tasks, such as optical flow calculation from a downscaled image.

The patch management system increases accuracy of texture reproduction and temporal noise reduction, resulting in higher image quality and more accurate optical flow. Additionally, by strategically selecting image areas for high-resolution patches, the patch management system minimizes computational overhead as compared to processing a full-resolution image. Thus, the patch management system can be used in applications that perform precise image analysis. Furthermore, the patch management system offers a cost-effective solution for devices that have limited processing power.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Patch Management System

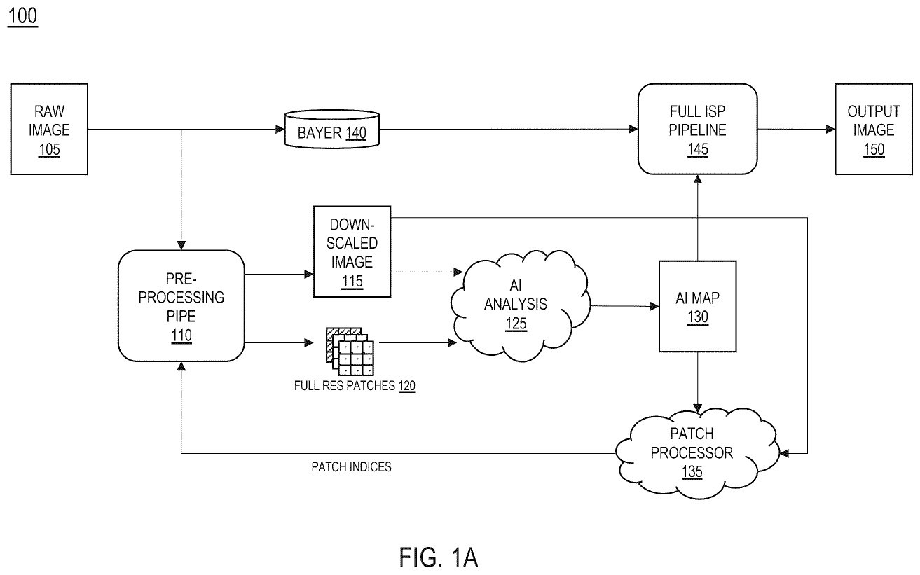

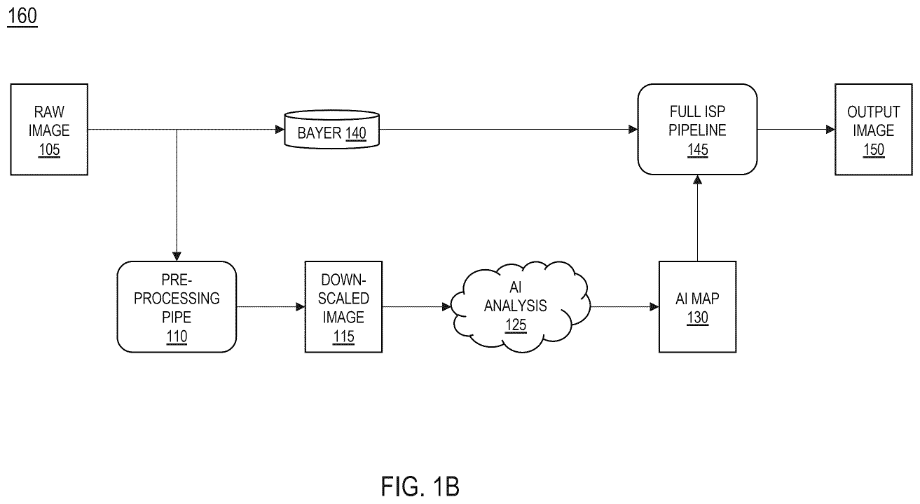

FIG. 1A is a block diagram of a patch management system 100, in accordance with various embodiments. The patch management system 100 is integrated into an early stage analysis pipeline, such as the early stage analysis pipeline 160 shown in FIG. 1B. The patch management system 100 includes a pre-processing pipe 110, an artificial intelligence analysis module 125, a patch processing module 135, and a full ISP pipeline 145.

As shown in FIG. 1A, a raw image 105 is received at the patch management system 100. The raw image 105 can be the raw unprocessed image from an image sensor, and, in some examples, the raw image can be a Bayer image or an RGB image. The raw image 105 is a current image frame, and the raw image 105 is input to the preprocessing pipe 110. The preprocessing pipe 110 outputs a downscaled image 115 of the raw image 105 and multiple full resolution patches 120 taken from the raw image 105. The full resolution patches 120 are patches from the raw image 105 at identified indices, where the preprocessing pipe 110 receives the patch indices from the patch processing module 135. The patch processing module 135 determined the patch indices based on the previous image frame, and patch processing module 135 processes the downscaled image 115 to identify patches and determine patch indices for the subsequent image frame.

The downscaled image 115, and an AI map 130, are input to a patch processing module 135. The patch processing module 135 can be a neural network such as a deep neural network and/or a convolutional neural network. In some examples, the patch processing module 135 is a cloud-based network. The patch processing module 135 analyzes the downscaled image 115 and the AI map 130, and identifies patches for high resolution processing. In various examples, the AI map 130 includes semantic segmentation information, where the semantic segmentation information includes semantic information for various segments of the in the downscaled image 115. Based on the semantic segmentation information, the patch processing module 135 identifies patches in the downscaled image 115 for the preprocessing pipe 110 to transmit in full resolution to the artificial intelligence analysis module 125 for processing.

In some implementations, the patch processing module 135 selects patches for additional texture analysis. For texture detection, the patch processing module 135 selects areas of the image that are towards the middle of a segment. In particular, the patch processing module 135 avoids edges of objects because a patch at an edge will have a high score variance due to the edge even if there is no texture in that object. In some examples, the patch processing module 135 analyzes flat regions in the downscaled image, and selects a patch near the center of a flat segment.

In some implementations, the patch processing module 135 selects patches for change detection. In some examples, for change detection the patch processing module 135 selects a window with meaningful information that will persist for a few consecutive frames. Thus the patch processing module 135 selects a patch that is in the middle of a segment such that it will not disappear after subsequent movements. In some examples, the patch processing module 135 finds corner points where changes between frames are more easily detectable. In particular, the patch processing module 135 identifies points in the image where intensity changes significantly in multiple directions.

The patch processing module 135 transmits the indices of the identified patches to the preprocessing pipe 110. According to various implementations, the patch processing module 135 analyzes a downscaled image of a previous image frame and the preprocessing pipe 110 selects the identified patches from the current image frame. Processing the downscaled image of the previous image frame at the patch processing module 135 prevents any additional latency in processing the current image frame.

The downscaled image 115 and the full resolution patches 120 taken from the current image frame (the raw image 105) are received at an artificial intelligence analysis module 125. The artificial intelligence analysis module 125 can be a cloud based system. In some examples, the artificial intelligence analysis module 125 is a neural network such as a deep neural network. In some examples, the artificial intelligence analysis module 125 is a convolutional neural network.

The artificial intelligence analysis module 125 analyzes the downscaled image 115 and the full resolution patches 120 and outputs an artificial intelligence map 130. In various examples, the artificial intelligence analysis module 125 performs sematic segmentation, which includes classifying each pixel in an image according to the category of the object or region it represents. By partitioning an image into semantically meaningful segments—such as sky, road, or person—semantic segmentation enables downstream processing modules to interpret contextual relationships and isolate features of interest with fine granularity. This pixel-level understanding can be used for other applications, such as object detection and scene understanding, by providing detailed maps of where and what objects are present within a scene.

In some examples, the artificial intelligence analysis module 125 analyzes the full resolution patches 120 in the context of the downscaled image 115 using a deep neural network to detect fine details that may have been lost in the downscaled image 115. By fusing the high resolution patch level information with semantic segmentation results based on the downscaled image 115, the artificial intelligence analysis module 125 generates an AI map 130 that provides the full ISP pipeline 145 with global context (including the semantic segmentation results) as well as local details (based, in part, on the full resolution patches 120). In various examples, the patch management system 100 improves texture reproduction and temporal noise reduction at the full ISP pipeline 145 while adding minimal overhead.

FIG. 1B illustrates a block diagram of another image processing system 160 according to various embodiments. The image processing system 160 includes a preprocessing pipe 110 which generates a downscaled image 115 for AI analysis 125. The results of the AI analysis 125 are an AI map 130 that is input to the full ISP pipeline 145. However, because the AI analysis 125 is performed on the downscaled image 115 without any additional information, some analysis may be inaccurate, such as texture estimation and change detection estimation.

### Example Downscaling and Simple Processing Module

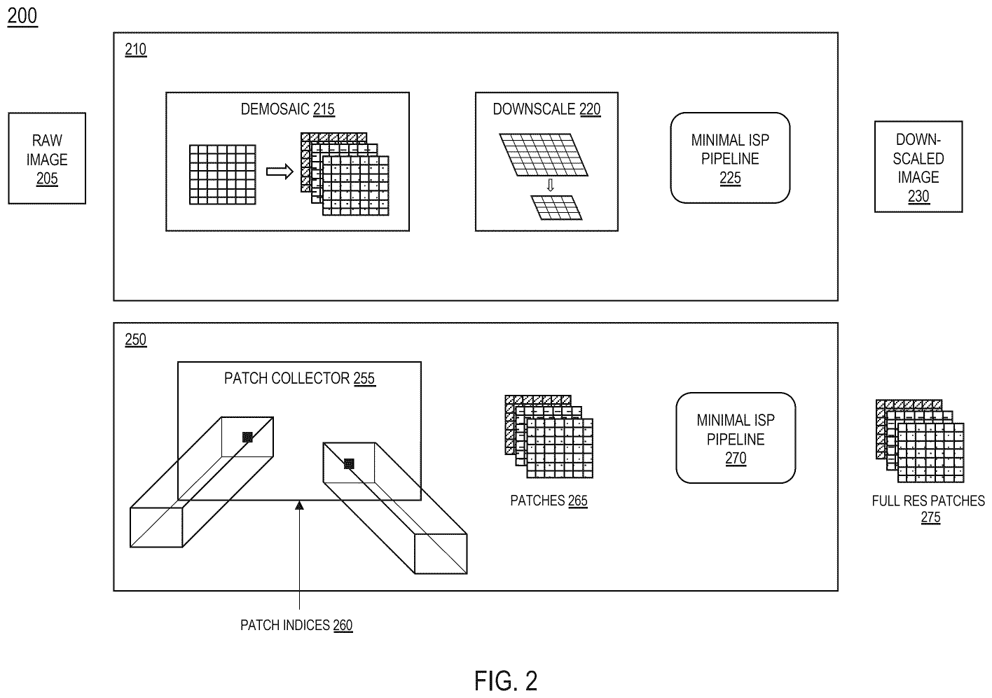

FIG. 2 is a block diagram of an ISP pre-processing pipeline 200 including a downscaling pre-processing pipeline 210 and a patch collection pipeline 250, in accordance with various embodiments. According to various implementations, the patch collection pipeline 250 is added to the downscaling preprocessing pipeline 210. Thus, the patch collection is added to the downscaling process. The downscaling preprocessing pipeline 210 reads the raw image 205 and converts it to a downscaled RGB image. In particular, in some examples, a demosaic block 215 converts the raw image 205 to an RGB image, and the downscale block 220 downscales the RGB image. The raw image 205 may be a raw Bayer image. The downscaled RGB image is processed at a minimal ISP pipeline 225, and which outputs a downscaled image 230.

According to various implementations, the patch collection pipeline 250 receives the full scale RGB image output from the demosaic block 215. In particular, a patch collector 255 receives the full scale RGB image and selects patches within the full scale RGB image for additional processing. As described above, with respect to FIG. 1A, the patch collector 255 selects patches based on patch indices received from a patch processing module, such as the patch processing module 135 described above with respect to FIG. 1A. The patch collector 255 outputs multiple patches 265 which are processed at a minimal ISP pipeline 270. The minimal ISP pipeline 270 performs ISP processing on the patches 265 and outputs multiple full resolution patches 275.

In some examples, the resolution after downscaling (i.e., the resolution of the downscaled image 230) is around 500×300 pixels. In various examples, adding 50 full resolution patches of size 17×17 pixels to enrich the frame analysis Increases the bandwidth by less than 10%.

According to various implementations, there are many possible strategies to select the patches and different types of patches can be selected for different purposes. In various examples, patch selection is based on the previous frame to prevent frame delays. In some examples, patches are selected within various segments of the image, to provide additional information about the segment. The segments of the image can be the segments identified during semantic segmentation, for example by an AI analysis module.

One patch selection strategy is patch selection for texture analysis. For texture analysis, the feature points, and thus the selected patch, is ideally close to the center of a segment. In particular, for accurate texture detection, the edges of an object are avoided. A window (or patch) at an edge of the object will have a high score of variances because of the edge, even if there is no texture in the window. Thus, selecting a patch towards the middle of a segment will minimize inaccurate texture detection.

Another patch selection strategy is patch selection for change detection. For change detection, a window is selected that includes meaningful information across a few frames. In particular, the window is selected such that it is in the middle of a segment, and the object(s) in the window will not disappear within a frame or two of movement.

To find the center of a segment, “center of mass” of the segment is determined. The center of mass can be determined by determining the first moment of the binary image of the segment. Thus, the center of mass (x, y) is calculated by:

$$\begin{matrix}\overline{x} = \frac{1}{A} \cdot {\sum }_{x , y ∈ I} x \cdot b ( x , y ) \\ \overline{y} = \frac{1}{A} \cdot {\sum }_{x , y ∈ I} y \cdot b ( x , y )\end{matrix}$$

Where A is the area of the segment, and b(x,y)=1 if both x,y∈S, and otherwise b(x,y)=0 for the current segment S.

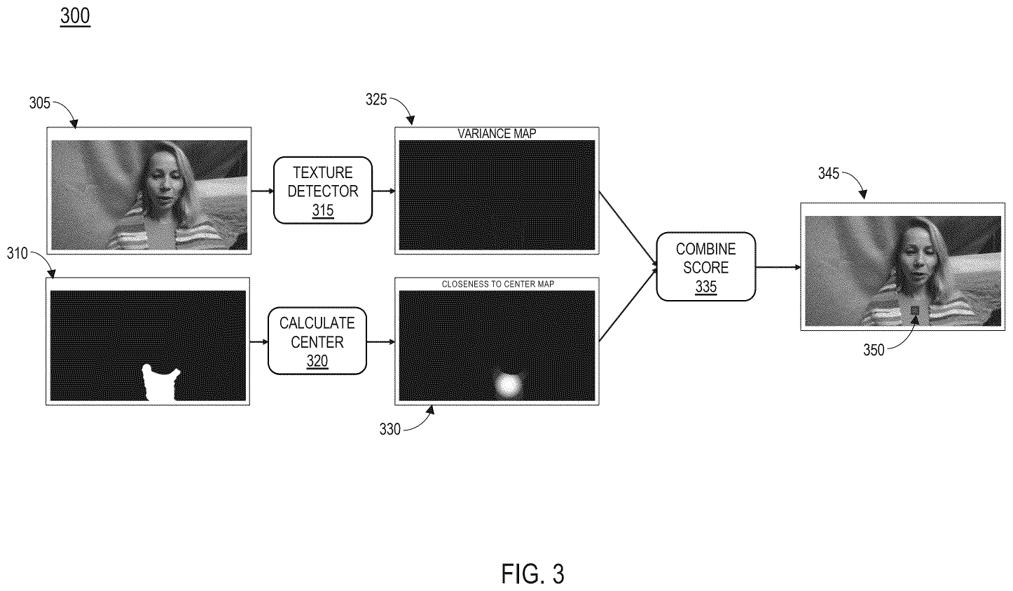

FIG. 3 is a block diagram 300 illustrating patch selection for texture analysis, in accordance with various embodiments. The downscaled image 305 is input to a texture detector 315, which outputs a variance map 325. Similarly, a segmentation mask image 310 with one selected segment highlighted is input to a calculate center module 320, which generates a map 330 indicating the closeness of the pixels in the segment to the center of the segment. In the example shown in FIG. 3, a flat region in the downscaled image is analyzed, where the flat region is the selected highlighted segment in the segmentation mask image 310. To identify and select a patch within the selected segment, the variance is determined within a 5×5 sliding window on the downscaled image, resulting in a variance map 325.

The various map 325 and the closeness-to-center map 330 are combined at the combine score module 335. The variance at each position of the 5×5 sliding window is weighted based on the distance of the respective position of the sliding window from the center of mass of the selected segment. In particular, the variance at each position of the sliding window can be weighted with the inverse distance from the center of the selected segment, such that minimal variance values indicate a more accurate patch. The combine score module 335 can determine a selected “best” patch based on the weighted variance values, where the selected patch has the lowest weighted variance score. The indices of the selected patch can be transmitted to a patch collector (e.g., patch collector 255), which can select and transmit full resolution patches corresponding to the received patch indices from the current images frame.

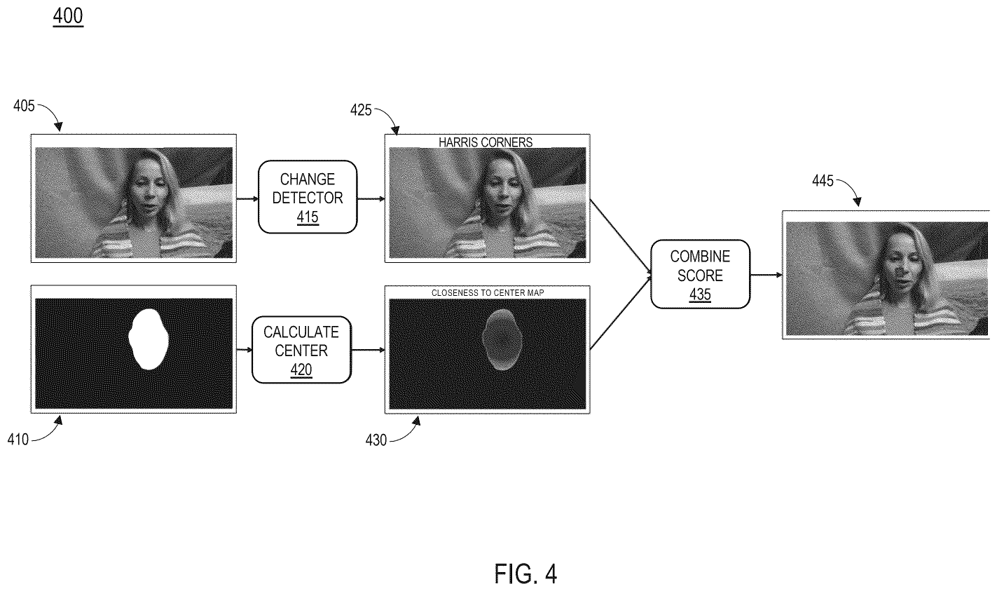

FIG. 4 is a block diagram 400 illustrating patch selection for change detection, in accordance with various embodiments. The downscaled image 405 is input to a change detector 415, which outputs an interest point map 325 highlighting interest points. In some examples, the change detector 415 is a Harris detector, which identifies key points in images, where the key points are referred to as interest points or corners. The change detector identifies points in the image 405 where the intensity changes sharply in multiple directions. The identified points generally correspond to corners, junctions, or other significant local.

The change detector 415 can be a Harris detector designed to find corner points. Corner points are identified because it is generally easiest to detect small changes between consecutive image frames at corner points. The change detector 415 identifies points in the downscaled image 405 where intensity changes significantly in multiple directions. In particular, the change detector 415 determines gradients, forming a covariance matrix for each pixel, and then analyzing the eigenvalues of the covariance matrix. In some examples, the covariance matrix represents a window of pixels, for example, a 5×5 window of pixels, though the window can be any selected size. High eigenvalues indicate a corner, making the method effective for finding stable feature points in the images 405. To perform change detection, the selected point is taken from two consecutive frames (e.g., the previous frame and the current frame, or the previous frame and the frame before the previous frame). Using two consecutive frames results in high-resolution patches in significant corresponding regions from the consecutive frames, which allows better predictions for local change between these frames. In some examples, the points of interest identified by the change detector 415 can also be used to increase accuracy of optical flow calculations from the downscaled image. The change detector 415 generates an interest point map 425 (e.g., a Harris corners map).

As discussed with respect to FIG. 3, a segmentation mask image 410 with one selected segment highlighted is input to a calculate center module 420, which generates a closeness-to-center map 430 indicating the closeness of the pixels in the segment to the center of the segment. In the example shown in FIG. 4, a moving region corresponding to a person's face in the downscaled image 405 is analyzed, where the moving region is the selected highlighted segment in the segmentation mask image 410. To identify and select a patch within the selected segment (corresponding to the persons face), the patch management system combines the closeness-to-center map 430 and the interest point map 425.

In particular, the interest point map 425 and the closeness-to-center map 430 are combined at the combine score module 435. The interest point values (e.g., the eigenvalues) can be weighted based on the distance of the respective position of the interest point from the center of mass of the selected segment. In some examples, the interest point values generated by the change detector 415 are divided by the distance of the respective interest point from the center, such that a high score that is close to the center will be a good patch. The combine score module 435 can determine a selected “best” patch based on the weighted variance values. The indices of the selected patch can be transmitted to a patch collector (e.g., patch collector 255), which can select and transmit full resolution patches corresponding to the received patch indices from the current images frame.

In some examples, the patches have a default size, and just a corner index for the patch is transmitted to the patch collector (e.g., a top left corner). The patch size can be set at any predetermined size. For example, the patch size can be set at 15×15 pixels, and the patch collector can collect a patch that extends 15 pixels horizontally and 15 pixels vertically from the pixel index received from a patch selection module. In other examples, the patch size can be 5×5 pixels, 10×10 pixels, 20×20 pixels, or any other selected width by length in pixels. The number of pixels of the width can be different from the number of pixels of the length. In other examples, patches can have variable sizes, and a patch size can be transmitted with the patch indices. In some examples, more than one patch can be selected for a segment from semantic segmentation. In some examples, when more than one patch is selected for a segment, non-maxima suppression can be applied and the next best value from the metric map can be selected.

In various examples, the patch is determined for a low-resolution image, and the corresponding patch is then retrieved from a high resolution image. Thus, in some examples, the patch in the low resolution image is 5×5 pixels, and the corresponding patch in the high resolution image is increased based on the magnitude of the downscaling that was performed on the image. Thus, for example, if the high resolution image was downscaled such that an 8×8 patch became 2×2 patch, then a 2×2 patch in the low resolution image is upscaled to an 8×8 patch taken from the corresponding area of the high resolution image. Additionally, the corresponding patch in the high resolution image is the patch that includes the same portion of the image frame as the low resolution image, such that the indices of the patch taken from the high resolution image corresponding to the indices of the patch identified in the low resolution image are different indices but refer to the same portion of the image. Thus, for example, if the high resolution image was downscaled such that an 8×8 patch became 2×2 patch, a 2×2 patch taken at indices {20,20} of the low resolution image may correspond to an 8×8 patch taken at indices {80×80} of the corresponding high resolution image.

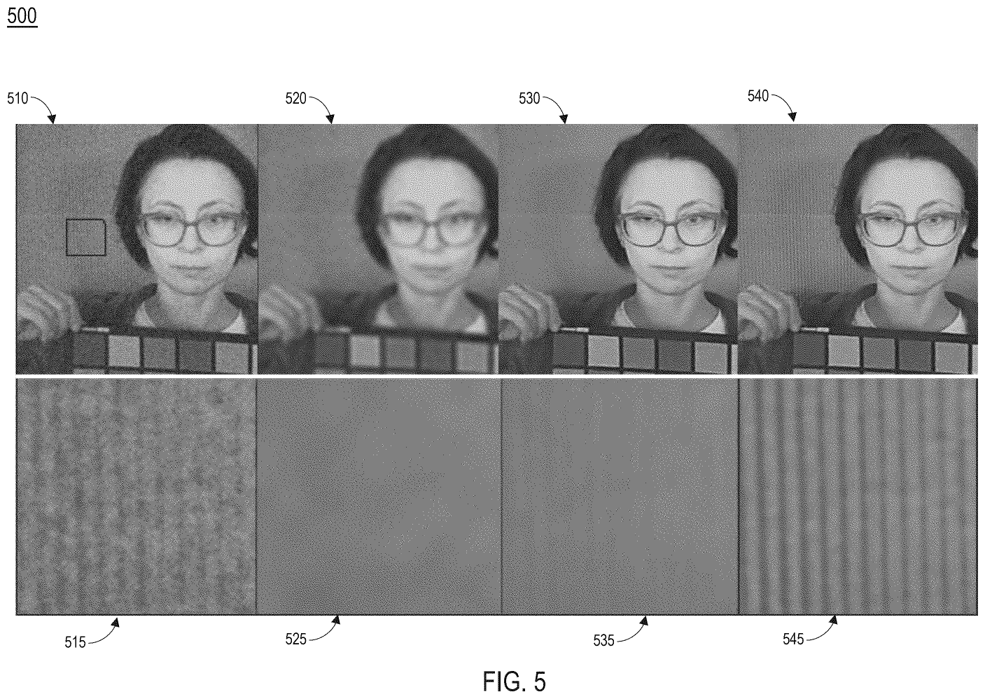

FIG. 5 illustrates an example of an image processed with and without a patch collector and a patch processing module, in accordance with various embodiments. The first image 510 on the left is the original image. The second image 520 is a downscaled version of the first image 510. The second image 520 is downscaled to ⅛ of the resolution of the first image 510. The fine texture in the background of the first image 510 is not visible in the second image 520, as highlighted in the zoomed in patch 525, under the main image. Configuring the denoising and sharpening parameters based solely on the downscaled second image 520 results in isotropic filtering, which leads to a loss of texture details, as illustrated in the third image 530. In contrast, the fourth image 540 is processed using a patch management system as described herein, and the texture is accurately recognized and enhanced.

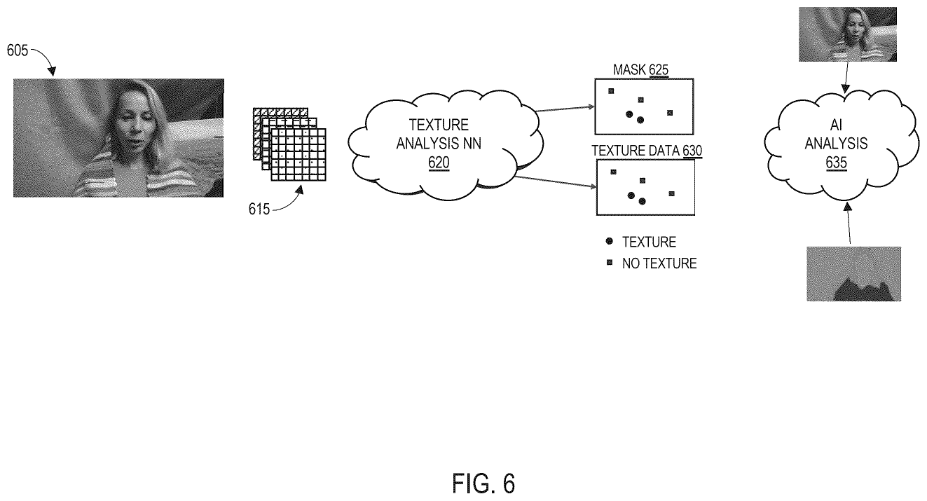

FIG. 6 is a block diagram 600 illustrating image processing including a patch processing module, in accordance with various embodiments. There are many ways the patches described herein can be used for image analysis. FIG. 6 illustrates one way use the patches for image analysis, in which patches are analyzed individually and a map is created from the information that can be input to an AI analysis module.

In the example shown in FIG. 6, the patch processing module is a texture analysis neural network 620. As shown in FIG. 6, an input image 605 and patches 615 are input to the texture analysis neural network 620. The texture analysis neural network 620 creates two masks. In particular, the texture analysis neural network 620 outputs a mask 625 that indicates the locations of the collected patches, and a texture data map 630 that indicates the texture data for each patch. The AI analysis module 635 can use the points in the mask 625 and the texture data map 630 in analyzing the image 605.

Another way in which the patches described herein can be used for image analysis is to apply voting to each segment (from sematic segmentation) based on the collected patches. For example, if most of the clothing segment has texture, the entire clothing segment can be treated as textured.

### Example Patch Processing Module

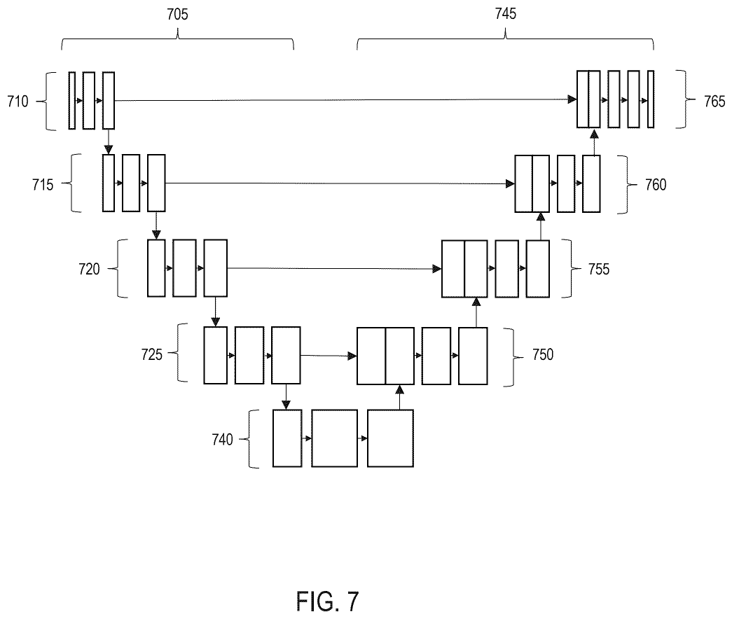

FIG. 7 is a block diagram of a patch processing module implemented as deep neural network 700, in accordance with various embodiments. The patch processing neural network 700 receives the low resolution image, for example from the pre-processing pipe 110. The patch processing neural network 700 model analyzes the image data, and identifies selected patches. In some examples, patches are selected for various segments from semantic segmentation. The output is a plurality of indices, indicating the locations of multiple patches in the original image that can be transmitted to an AI analysis module to provide additional information for image processing.

The patch processing neural network 700, as shown in FIG. 7, is a Convolutional Neural Network (CNN), a type of deep learning model. Additionally, the patch processing neural network 700 as shown in FIG. 7 has a U-Net shaped architecture, including an encoder 705 and a decoder 745. The input to the patch processing neural network 700 is a downscaled RGB image with three channels, such as the downscaled image 115 generated by the pre-processing pipe 110. In some examples, an AI map, such as a segmentation map from an AI analysis module is also input to the patch processing neural network 700. The resolution of the input image is M×N×3. In various examples, the larger dimension of the image (height or width) is less than or equal to 512. The aspect ratio of the downscaled image is preserved from the original full-size image.

In the encoder 705 stage, the patch processing neural network 700 includes several layers, grouped in the U-Net architecture into first layers 710, second layers 715, third layers 720, and fourth layers 725, each operating on a different scale (i.e., different spatial dimensions) and designed to extract distinct features from the input image. In various examples, the first layers 710, second layers 715, third layers 720, and fourth layers 725 each include multiple layers, including two convolutional layers and one max pooling layer. In particular, the first two layers in each group operate on a larger spatial dimension, applying a series of filters to the image to detect low-level features like edges and textures. In some examples, the first two layers in each group are 7×3 convolution layers. These layers are followed by max pooling layers, which reduce the data's dimensionality while preserving the most important information and increasing the number of channels. In some examples, the max pooling layers are 2×2 max pooling layers. The increase in the number of channels is designed to incorporate semantic knowledge into the texture estimation process. In some examples, the output from the max pooling layer is received at a next convolutional layer. The output from the max pooling layer can also be connected to a corresponding decoding layer via a skip connect.

The convolution layers and max pooling are repeated four times, in first layers 710, second layers 715, third layers 720, and fourth layers 725, to reach the bottleneck information at the fifth layer 740. In some examples, the fifth layer 740 has the size of M/16×N/16×1024. The fifth layer includes two 7×3 convolutional layers and a 2×2 up-convolution layer, in which a 2×2 up-convolution operator is applied to upscale the feature maps to a higher scale.

In the decoder 745 stage, the patch processing neural network 700 includes several layers, grouped in the U-Net architecture into fourth layers 750, third layers 755, second layers 760, and first layers 765, each operating on a different scale. At each stage, a 2×2 up-convolution operator is applied to upscale the feature maps to a higher scale. A concatenation operator then combines the matching scale from the corresponding encoder layer, via the skip connect. This is followed by several convolution layers to process the upscaled and concatenated features together. These operations are repeated in the decoder stage until the spatial resolution of the input image is restored. The patch processing neural network's final layer is a 1×1 convolution layer, which serves as a fully connected layer per pixel, combining the features extracted by the previous layers to make the final patch determinations.

### Example Method for Patch Processing

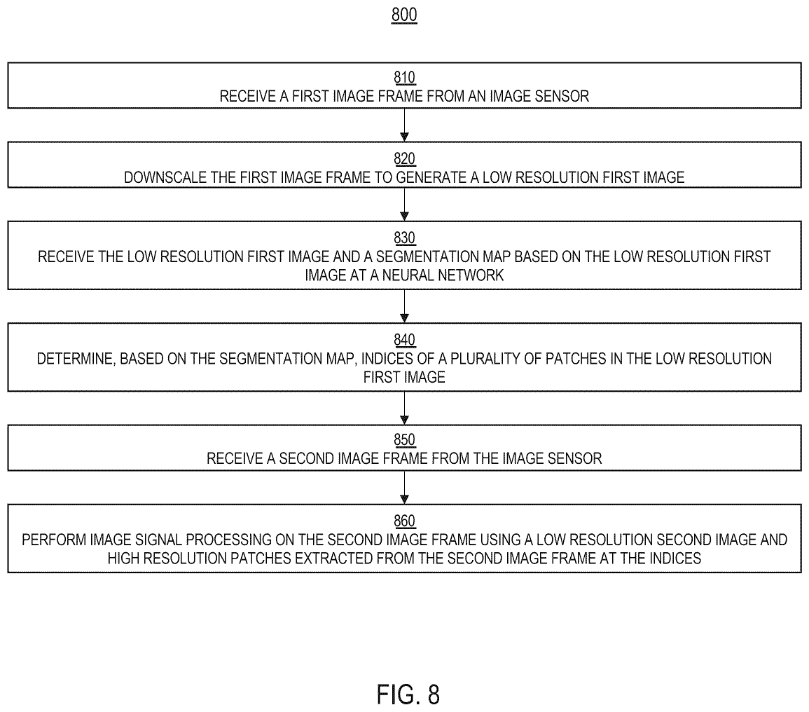

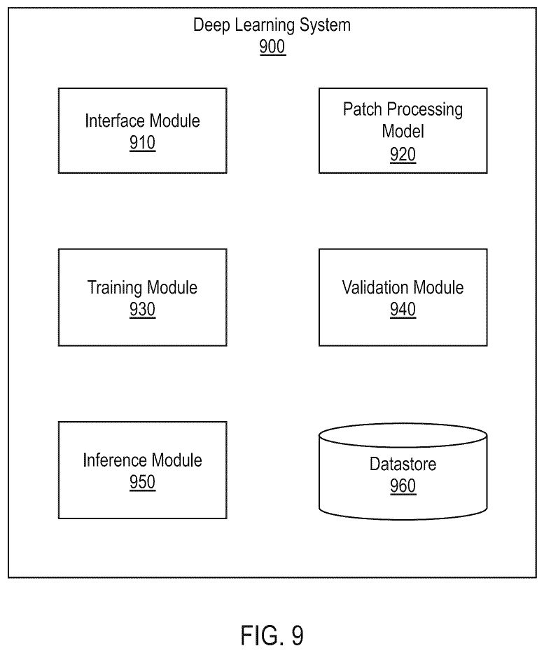

FIG. 8 is a flowchart showing a method 800 for patch processing, in accordance with various embodiments. The method 800 may be performed by the system 100 of FIG. 1A, and/or by the deep learning system 900 in FIG. 9. Although the method 800 is described with reference to the flowchart illustrated in FIG. 8, other methods for change detection may alternatively be used. For example, the order of execution of the steps in FIG. 8 may be changed. As another example, some of the steps may be changed, eliminated, or combined.

At 810, a first input image frame is received from an image sensor. In some examples, an input video stream is received, including multiple consecutive image frames. The first input image (or input video stream) can be input to an ISP for pre-processing, as described, for example, with respect to FIG. 1A. The first input image can be a raw image, and the first input image can be a high resolution image.

At step 820, the first input image is downscaled to generate a low resolution first image. At 830, the low resolution first image is received at a neural network, such as a patch processing neural network. A segmentation map can be generated based on the low resolution first image, and the segmentation map is also received at the neural network.

At 840, indices of a plurality of patches in the low resolution first image are determined based on the segmentation map. In various examples, the patch processing neural network identifies regions in the low resolution first image where small high resolution patches can provide additional information to increase image processing accuracy. For example, the patch processing neural network can identify flat regions in the low resolution first image, and determine patch locations where a small window from the high resolution first image can be used to determine whether there is a texture in the identified flat regions. Similarly, the patch processing neural network can identify Harris corners in the low resolution first image, and determine patch locations where a small window from the high resolution first image can be used to determine whether there is movement or change at the Harris corners. In some examples, to detect movement or change, a second image is used, and the identified patch indices are used to analyze the corresponding patches in the second image.

At 850, a second image frame is received from the image sensor. The second image frame can be downscaled to generate a low resolution second image. Additionally, a second plurality of patches can be generated from the second image frame at image locations corresponding to the indices of the first plurality of patches. In particular, as described above, the second plurality of patches represent the same portions of the image as the first plurality of patches. Thus, for example, if the low resolution image was downscaled such that a 5×5 patch in the low resolution image corresponds to a 20×20 patch in the high resolution image, then patches in the first plurality of patches that are 5×5 pixels in size correspond to patches in the second plurality of patches that are 20×20 pixels in size. The indices of the patch locations are similarly scaled such that the second plurality of patches represent the same portions of the image frame as the first plurality of patches.

At 860, image signal processing is performed on the second image frame using a low resolution second image and high resolution patches (the second plurality of patches) extracted from the second image frame at the patch indices identified by the patch processing neural network. In some examples, performing image signal processing on the second image frame includes adjusting textured areas to enhance texture based, at least in part, on one or more patches of the second plurality of patches. In some examples, performing image signal processing on the second image frame includes adjusting textured areas to enhance texture based, at least in part, on one or more patches of the second plurality of patches. In some examples, performing image signal processing on the second image frame includes sharpening edges and fine details based, at least in part, on one or more patches of the second plurality of patches. In some examples, performing image signal processing on the second image frame includes adjusting image contrast to optimize the range between light and dark regions based, at least in part, on one or more patches of the second plurality of patches. In some examples, performing image signal processing on the second image frame includes performing color correction to adjust white balance and color fidelity for natural and accurate color representations based, at least in part, on the one or more patches of the second plurality of patches.

An output image is generated based on the output of the image signal processing of the second image frame, wherein the output image is a full resolution image.

### Example DNN for Patch Processing

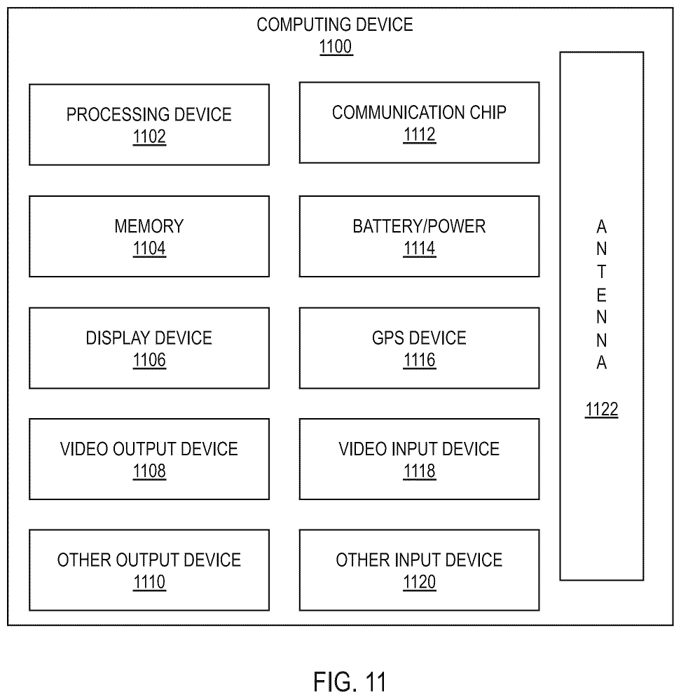

FIG. 9 is a block diagram of an example DNN system 900, in accordance with various embodiments. The DNN system 900 trains DNNs for various tasks, including patch processing for images. The DNN system 900 includes an interface module 910, a patch processing model 920, a training module 930, a validation module 940, an inference module 950, and a datastore 960. In other embodiments, alternative configurations, different or additional components may be included in the DNN system 900. Further, functionality attributed to a component of the DNN system 900 may be accomplished by a different component included in the DNN system 900 or a different system. The DNN system 900 or a component of the DNN system 900 (e.g., the training module 930 or inference module 950) may include the computing device 1100 in FIG. 11.

The interface module 910 facilitates communications of the DNN system 900 with other systems. As an example, the interface module 910 supports the DNN system 900 to distribute trained DNNs to other systems, e.g., computing devices configured to apply DNNs to perform tasks. As another example, the interface module 910 establishes communications between the DNN system 900 with an external database to receive data that can be used to train DNNs or input into DNNs to perform tasks. In some embodiments, data received by the interface module 910 may have a data structure, such as a matrix. In some embodiments, data received by the interface module 910 may be an image, a series of images, and/or a video stream.

The patch processing model 920 predicts texture of pixels in images. In some examples, the patch processing model 920 performs patch processing on low resolution images and segmentation maps. In general, the patch processing model includes an encoder and a decoder. The patch processing model receives downscaled image data (i.e., a low resolution version of the input image) and a segmentation map, and identifies a plurality of patches for collecting from the high resolution image. During training, the patch processing model 920 can use ground truth patch processing maps.

The training module 930 trains DNNs by using training datasets. In some embodiments, a training dataset for training a DNN may include one or more images and/or videos, each of which may be a training sample. In some examples, the training module 930 trains the patch processing model 920. The training module 930 may receive real-world image data for processing with the patch processing model 920 as described herein. In some embodiments, the training module 930 may input different data into different layers of the DNN. For every subsequent DNN layer, the input data may be less than the previous DNN layer. In some examples, the patch processing model 920 can be trained with ground truth maps of images having a plurality of selected patches. In some examples, the difference between patch processing model 920 patch processing map output and the corresponding groundtruth patch processing map can be measured as the number of pixels in the corresponding maps that have different classifications from each other.

In some embodiments, a part of the training dataset may be used to initially train the DNN, and the rest of the training dataset may be held back as a validation subset used by the validation module 940 to validate performance of a trained DNN. The portion of the training dataset not including the tuning subset and the validation subset may be used to train the DNN.

The training module 930 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 930 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different categories by training.

In the process of defining the architecture of the DNN, the training module 930 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 930 defines the architecture of the DNN, the training module 930 inputs a training dataset into the DNN. The training dataset includes a plurality of training samples. An example of a training dataset includes a series of images of a video stream. Unlabeled, real-world video is input to the patch processing model, and processed using the patch processing model parameters of the DNN to produce two different model-generated outputs: a first time-forward model-generated output and a second time-reversed model-generated output. In the backward pass, the training module 930 modifies the parameters inside the DNN (“internal parameters of the DNN”) to minimize the differences between the first model-generated output is and the second model-generated output. The internal parameters include weights of filters in the convolutional layers of the DNN. In some embodiments, the training module 930 uses a cost function to minimize the differences.

The training module 930 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 930 finishes the predetermined number of epochs, the training module 930 may stop updating the parameters in the DNN. The DNN having the updated parameters is referred to as a trained DNN.

The validation module 940 verifies accuracy of trained DNNs. In some embodiments, the validation module 940 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 940 may determine an accuracy score measuring the precision, recall, or a combination of precision and recall of the DNN. The validation module 940 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 940 may compare the accuracy score with a threshold score. In an example where the validation module 940 determines that the accuracy score of the augmented model is lower than the threshold score, the validation module 940 instructs the training module 930 to re-train the DNN. In one embodiment, the training module 930 may iteratively re-train the DNN until the occurrence of a stopping condition, such as the accuracy measurement indication that the DNN may be sufficiently accurate, or a number of training rounds having taken place.

The inference module 950 applies the trained or validated DNN to perform tasks. The inference module 950 may run inference processes of a trained or validated DNN. In some examples, inference makes use of the forward pass to produce model-generated output for unlabeled real-world data. For instance, the inference module 950 may input real-world data into the DNN and receive an output of the DNN. The output of the DNN may provide a solution to the task for which the DNN is trained for.

The inference module 950 may aggregate the outputs of the DNN to generate a final result of the inference process. In some embodiments, the inference module 950 may distribute the DNN to other systems, e.g., computing devices in communication with the DNN system 900, for the other systems to apply the DNN to perform the tasks. The distribution of the DNN may be done through the interface module 910. In some embodiments, the DNN system 900 may be implemented in a server, such as a cloud server, an edge service, and so on. The computing devices may be connected to the DNN system 900 through a network. Examples of the computing devices include edge devices.

The datastore 960 stores data received, generated, used, or otherwise associated with the DNN system 900. For example, the datastore 960 stores video processed by the patch processing model 920 or used by the training module 930, validation module 940, and the inference module 950. The datastore 960 may also store other data generated by the training module 930 and validation module 940, such as the hyperparameters for training DNNs, internal parameters of trained DNNs (e.g., values of tunable parameters of activation functions, such as Fractional Adaptive Linear Units (FALUs)), etc. In the embodiment of FIG. 9, the datastore 960 is a component of the DNN system 900. In other embodiments, the datastore 960 may be external to the DNN system 900 and communicate with the DNN system 900 through a network.

For patch processing model training, the input can include an input image frame and a labeled groundtruth patch processing model-processed image. In various examples, the input image frame is received at a temporal noise reducer such as the patch processing model of image processing systems 100, 200, or the patch processing model 920. In other examples, the input image frame can be received at the training module 930 or the inference module 950 of FIG. 9. The imager can be a camera, such as a video camera. The input image frame can be a still image from the video camera feed. The input image frame can include a matrix of pixels, each pixel having a color, lightness, and/or other parameter. The input image frame can be downscaled and processed by the AI analysis block, and the input image frame can be simultaneously processed (in parallel) by an image processing pipe. Various steps can be repeated to further adjust the patch processing model parameters. In some examples, the training can be repeated with a new input image frame and groundtruth patch processing model-processed image.

### Example CNN System for Patch Processing

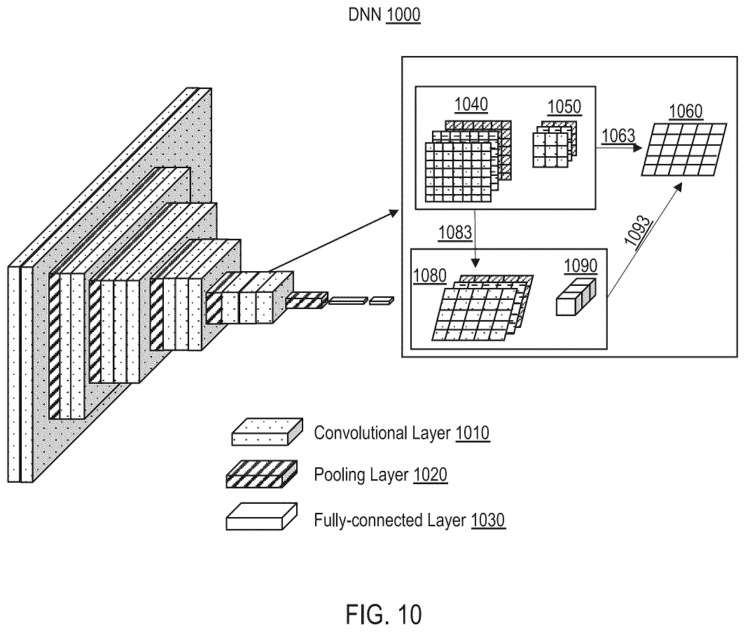

FIG. 10 illustrates an example DNN 1000, in accordance with various embodiments. For purpose of illustration, the DNN 1000 in FIG. 10 is a CNN. In other embodiments, the DNN 1000 may be other types of DNNs. The DNN 1000 is trained to receive images and output classifications of objects in the images. In the embodiments of FIG. 10, the DNN 1000 receives an input image 1005 that includes objects. The DNN 1000 includes a sequence of layers comprising a plurality of convolutional layers 1010 (individually referred to as “convolutional layer 1010”), a plurality of pooling layers 1020 (individually referred to as “pooling layer 1020”), and a plurality of fully connected layers 1030 (individually referred to as “fully connected layer 1030”). In other embodiments, the DNN 1000 may include fewer, more, or different layers. In an inference of the DNN 1000, the layers of the DNN 1000 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 1010 summarize the presence of features in the input image 1005. The convolutional layers 1010 function as feature extractors. The first layer of the DNN 1000 is a convolutional layer 1010. In an example, a convolutional layer 1010 performs a convolution on an input tensor 1040 (also referred to as IFM 1040) and a filter 1050. As shown in FIG. 10, the IFM 1040 is represented by a 7×7×3 three-dimensional (3D) matrix. The IFM 1040 includes 3 input channels, each of which is represented by a 7×7 two-dimensional (2D) matrix. The 7×7 2D matrix includes 7 input elements (also referred to as input points) in each row and seven input elements in each column. The filter 1050 is represented by a 3×3×3 3D matrix. The filter 1050 includes 3 kernels, each of which may correspond to a different input channel of the IFM 1040. A kernel is a 2D matrix of weights, where the weights are arranged in columns and rows. A kernel can be smaller than the IFM. In the embodiments of FIG. 10, each kernel is represented by a 3×3 2D matrix. The 3×3 kernel includes 3 weights in each row and three weights in each column. Weights can be initialized and updated by backpropagation using gradient descent. The magnitudes of the weights can indicate importance of the filter 1050 in extracting features from the IFM 1040.

The convolution includes MAC operations with the input elements in the IFM 1040 and the weights in the filter 1050. The convolution may be a standard convolution 1063 or a depthwise convolution 1083. In the standard convolution 1063, the whole filter 1050 slides across the IFM 1040. All the input channels are combined to produce an output tensor 1060 (also referred to as output feature map (OFM) 1060). The OFM 1060 is represented by a 5×5 2D matrix. The 5×5 2D matrix includes 5 output elements (also referred to as output points) in each row and five output elements in each column. For purpose of illustration, the standard convolution includes one filter in the embodiments of FIG. 10. In embodiments where there are multiple filters, the standard convolution may produce multiple output channels in the OFM 1060.

The multiplication applied between a kernel-sized patch of the IFM 1040 and a kernel may be a dot product. A dot product is the elementwise multiplication between the kernel-sized patch of the IFM 1040 and the corresponding kernel, which is then summed, always resulting in a single value. Because it results in a single value, the operation is often referred to as the “scalar product.” Using a kernel smaller than the IFM 1040 is intentional as it allows the same kernel (set of weights) to be multiplied by the IFM 1040 multiple times at different points on the IFM 1040. Specifically, the kernel is applied systematically to each overlapping part or kernel-sized patch of the IFM 1040, left to right, top to bottom. The result from multiplying the kernel with the IFM 1040 one time is a single value. As the kernel is applied multiple times to the IFM 1040, the multiplication result is a 2D matrix of output elements. As such, the 2D output matrix (i.e., the OFM 1060) from the standard convolution 1063 is referred to as an OFM.

In the depthwise convolution 1083, the input channels are not combined. Rather, MAC operations are performed on an individual input channel and an individual kernel and produce an output channel. As shown in FIG. 10, the depthwise convolution 1083 produces a depthwise output tensor 1080. The depthwise output tensor 1080 is represented by a 5×5×3 3D matrix. The depthwise output tensor 1080 includes 3 output channels, each of which is represented by a 5×5 2D matrix. The 5×5 2D matrix includes 5 output elements in each row and five output elements in each column. Each output channel is a result of MAC operations of an input channel of the IFM 1040 and a kernel of the filter 1050. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 1093 is then performed on the depthwise output tensor 1080 and a 1×1×3 tensor 1090 to produce the OFM 1060.

The OFM 1060 is then passed to the next layer in the sequence. In some embodiments, the OFM 1060 is passed through an activation function. An example activation function is the rectified linear activation function (ReLU). ReLU is a calculation that returns the value provided as input directly, or the value zero if the input is zero or less. The convolutional layer 1010 may receive several images as input and calculate the convolution of each of them with each of the kernels. This process can be repeated several times. For instance, the OFM 1060 is passed to the subsequent convolutional layer 1010 (i.e., the convolutional layer 1010 following the convolutional layer 1010 generating the OFM 1060 in the sequence). The subsequent convolutional layers 1010 perform a convolution on the OFM 1060 with new kernels and generates a new feature map. The new feature map may also be normalized and resized. The new feature map can be kernelled again by a further subsequent convolutional layer 1010, and so on.

In some embodiments, a convolutional layer 1010 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 1010). The convolutional layers 1010 may perform various types of convolutions, such as 2-dimensional convolution, dilated or atrous convolution, spatial separable convolution, depthwise separable convolution, transposed convolution, and so on. The DNN 1000 includes 16 convolutional layers 1010. In other embodiments, the DNN 1000 may include a different number of convolutional layers.

The pooling layers 1020 down-sample feature maps generated by the convolutional layers, e.g., by summarizing the presence of features in the patches of the feature maps. A pooling layer 1020 is placed between two convolution layers 1010: a preceding convolutional layer 1010 (the convolution layer 1010 preceding the pooling layer 1020 in the sequence of layers) and a subsequent convolutional layer 1010 (the convolution layer 1010 subsequent to the pooling layer 1020 in the sequence of layers). In some embodiments, a pooling layer 1020 is added after a convolutional layer 1010, e.g., after an activation function (e.g., ReLU, etc.) has been applied to the OFM 1060.

A pooling layer 1020 receives feature maps generated by the preceding convolution layer 1010 and applies a pooling operation to the feature maps. The pooling operation reduces the size of the feature maps while preserving their important characteristics. Accordingly, the pooling operation improves the efficiency of the DNN and avoids over-learning. The pooling layers 1020 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 1020 applied to a feature map of 6×6 results in an output pooled feature map of 3×3. The output of the pooling layer 1020 is inputted into the subsequent convolution layer 1010 for further feature extraction. In some embodiments, the pooling layer 1020 operates upon each feature map separately to create a new set of the same number of pooled feature maps.

The fully connected layers 1030 are the last layers of the DNN. The fully connected layers 1030 may be convolutional or not. The fully connected layers 1030 receive an input operand. The input operand defines the output of the convolutional layers 1010 and pooling layers 1020 and includes the values of the last feature map generated by the last pooling layer 1020 in the sequence. The fully connected layers 1030 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 1030 by using a logistic function (binary classification) or a softmax function (multi-class classification) as an activation function.

In some embodiments, the fully connected layers 1030 classify the input image 1005 and return an operand of size N, where N is the number of classes in the image classification problem. In the embodiments of FIG. 10, N equals 3, as there are three objects 1015, 1025, and 1035 in the input image. Each element of the operand indicates the probability for the input image 1005 to belong to a class. To calculate the probabilities, the fully connected layers 1030 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 1015 being a tree, a second probability indicating the object 1025 being a car, and a third probability indicating the object 1035 being a person. In other embodiments where the input image 1005 includes different objects or a different number of objects, the individual values can be different.

### Example Computing Device

FIG. 11 is a block diagram of an example computing device 1100, in accordance with various embodiments. In some embodiments, the computing device 1100 may be used for at least part of the deep learning system 900 in FIG. 9. A number of components are illustrated in FIG. 11 as included in the computing device 1100, but any one or more of these components may be omitted or duplicated, as suitable for the application. In some embodiments, some or all of the components included in the computing device 1100 may be attached to one or more motherboards. In some embodiments, some or all of these components are fabricated onto a single system on a chip (SoC) die. Additionally, in various embodiments, the computing device 1100 may not include one or more of the components illustrated in FIG. 11, but the computing device 1100 may include interface circuitry for coupling to the one or more components. For example, the computing device 1100 may not include a display device 1106, but may include display device interface circuitry (e.g., a connector and driver circuitry) to which a display device 1106 may be coupled. In another set of examples, the computing device 1100 may not include a video input device 1118 or a video output device 1108, but may include video input or output device interface circuitry (e.g., connectors and supporting circuitry) to which a video input device 1118 or video output device 1108 may be coupled.

The computing device 1100 may include a processing device 1102 (e.g., one or more processing devices). The processing device 1102 processes electronic data from registers and/or memory to transform that electronic data into other electronic data that may be stored in registers and/or memory. The computing device 1100 may include a memory 1104, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1104 may include memory that shares a die with the processing device 1102. In some embodiments, the memory 1104 includes one or more non-transitory computer-readable media storing instructions executable for occupancy mapping or collision detection, e.g., the method 500 described above in conjunction with FIG. 5 or some operations performed by the DNN system 900 in FIG. 9. The instructions stored in the one or more non-transitory computer-readable media may be executed by the processing device 1102.

In some embodiments, the computing device 1100 may include a communication chip 1112 (e.g., one or more communication chips). For example, the communication chip 1112 may be configured for managing wireless communications for the transfer of data to and from the computing device 1100. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1112 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1112 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1112 may operate in accordance with other wireless protocols in other embodiments. The computing device 1100 may include an antenna 1122 to facilitate wireless communications and/or to receive other wireless communications (such as AM or FM radio transmissions).

In some embodiments, the communication chip 1112 may manage wired communications, such as electrical, optical, or any other suitable communication protocols (e.g., the Ethernet). As noted above, the communication chip 1112 may include multiple communication chips. For instance, a first communication chip 1112 may be dedicated to shorter-range wireless communications such as Wi-Fi or Bluetooth, and a second communication chip 1112 may be dedicated to longer-range wireless communications such as global positioning system (GPS), EDGE, GPRS, CDMA, WiMAX, LTE, EV-DO, or others. In some embodiments, a first communication chip 1112 may be dedicated to wireless communications, and a second communication chip 1112 may be dedicated to wired communications.

The computing device 1100 may include battery/power circuitry 1114. The battery/power circuitry 1114 may include one or more energy storage devices (e.g., batteries or capacitors) and/or circuitry for coupling components of the computing device 1100 to an energy source separate from the computing device 1100 (e.g., AC line power).

The computing device 1100 may include a display device 1106 (or corresponding interface circuitry, as discussed above). The display device 1106 may include any visual indicators, such as a heads-up display, a computer monitor, a projector, a touchscreen display, a liquid crystal display (LCD), a light-emitting diode display, or a flat panel display, for example.

The computing device 1100 may include a video output device 1108 (or corresponding interface circuitry, as discussed above). The video output device 1108 may include any device that generates an audible indicator, such as speakers, headsets, or earbuds, for example.

The computing device 1100 may include a video input device 1118 (or corresponding interface circuitry, as discussed above). The video input device 1118 may include any device that generates a signal representative of a sound, such as microphones, microphone arrays, or digital instruments (e.g., instruments having a musical instrument digital interface (MIDI) output).

The computing device 1100 may include a GPS device 1116 (or corresponding interface circuitry, as discussed above). The GPS device 1116 may be in communication with a satellite-based system and may receive a location of the computing device 1100, as known in the art.

The computing device 1100 may include another output device 1110 (or corresponding interface circuitry, as discussed above). Examples of the other output device 1110 may include a video codec, a video codec, a printer, a wired or wireless transmitter for providing information to other devices, or an additional storage device.

The computing device 1100 may include another input device 1120 (or corresponding interface circuitry, as discussed above). Examples of the other input device 1120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1100 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1100 may be any other electronic device that processes data.

### Selected Examples

The following paragraphs provide various examples of the embodiments disclosed herein.

Example 1 provides a computer-implemented method, including receiving a first image frame from an image sensor; downscaling the first image frame to generate a low resolution first image; generating a segmentation map based on the low resolution first image; receiving, at a neural network, the low resolution first image and the segmentation map; determining, based on the segmentation map, indices of a first plurality of patches in the low resolution image; receiving a second image frame from the image sensor; downscaling the second image frame to generate a low resolution second image; generating a second plurality of patches from the second image frame at locations corresponding to the first plurality of patches; and performing image signal processing on the second image frame using the low resolution second image and the second plurality of patches to generate an enhanced second image frame; generating an output image based on the enhanced second image frame, wherein the output image is a full resolution image.

Example 2 provides the computer-implemented method according to example 1, where determining the indices of the first plurality of patches includes identifying a flat region in the low resolution first image; and determining first indices of a first patch for texture analysis in the flat region.

Example 3 provides the computer-implemented method according to example 2, where generating the second plurality of patches includes generating a second patch at second indices of the second image frame corresponding to a portion of the low resolution first image of the first indices of the first patch, and where performing image signal processing on the second image frame includes collecting texture data for the second patch.

Example 4 provides the computer-implemented method according to example 2, wherein determining the first indices of the first patch includes generating a variance map for the low resolution first image, determining a plurality of variances within a corresponding plurality of windows in the low resolution first image.

Example 5 provides the computer-implemented method according to example 4, wherein determining the first indices of the first patch further includes identifying a center of a segment in the segmentation map, and generating a score for each of the plurality of windows within the segment including weighting a respective variance for each of the plurality of windows within the segment based on a respective distance between a corresponding window and the center of the segment.

Example 6 provides the computer-implemented method according to example 1, where determining the indices of the first plurality of patches includes identifying a region of intensity change in the low resolution first image; and determining first indices of a first patch for change detection in the region of intensity change.

Example 7 provides the computer-implemented method according to example 6, where generating the second plurality of patches includes generating a second patch at second indices of the second image frame corresponding to a portion of the low resolution first image of the first indices of the first patch, and where performing image signal processing on the second image frame includes collecting change data for the second patch.

Example 8 provides the computer-implemented method according to example 7, where performing image signal processing on the second image frame includes collecting change data for a corresponding patch in the first image frame, and identifying changes between the second patch and the corresponding patch.

Example 9 provides the computer-implemented method according to any one of examples 1-8, where the neural network is a first neural network, and where performing image signal processing on the second image frame includes analyzing, at a second neural network, the second plurality of patches for one of texture analysis and change detection.

Example 10 provides the computer-implemented method according to any one of examples 1-9, further including generating a map including locations of the first plurality of patches.

Example 11 provides one or more non-transitory computer-readable media storing instructions executable to perform operations, the operations including receiving a first image frame from an image sensor; downscaling the first image frame to generate a low resolution first image; generating a segmentation map based on the low resolution first image; receiving, at a neural network, the low resolution first image and the segmentation map; determining, based on the segmentation map, indices of a first plurality of patches in the low resolution image; receiving a second image frame from the image sensor; downscaling the second image frame to generate a low resolution second image; generating a second plurality of patches from the second image frame at locations corresponding to the first plurality of patches; performing image signal processing on the second image frame using the low resolution second image and the second plurality of patches to generate an enhanced second image frame; and generating an output image based on the enhanced second image frame, wherein the output image is a full resolution image.

Example 12 provides the one or more non-transitory computer-readable media according to example 11, where determining the indices of the first plurality of patches includes identifying a flat region in the low resolution first image; and determining first indices of a first patch for texture analysis in the flat region.

Example 13 provides the one or more non-transitory computer-readable media according to example 12, where generating the second plurality of patches includes generating a second patch at second indices of the second image frame corresponding to a portion of the low resolution first image of the first indices of the first patch, and where performing image signal processing on the second image frame includes collecting texture data for the second patch.

Example 14 provides the one or more non-transitory computer-readable media according to example 11, where determining the indices of the first plurality of patches includes identifying a region of intensity change in the low resolution first image; and determining first indices of a first patch for change detection in the region of intensity change.

Example 15 provides the one or more non-transitory computer-readable media according to example 14, where generating the second plurality of patches includes generating a second patch at second indices of the second image frame corresponding to a portion of the low resolution first image of the first indices of the first patch, and where performing image signal processing on the second image frame includes collecting change data for the second patch.

Example 16 provides the one or more non-transitory computer-readable media according to example 15, where performing image signal processing on the second image frame includes collecting change data for a corresponding patch in the first image frame, and identifying changes between the second patch and the corresponding patch.

Example 17 provides the one or more non-transitory computer-readable media according to any one of examples 11-16, where the neural network is a first neural network, and where performing image signal processing on the second image frame includes analyzing, at a second neural network, the second plurality of patches for one of texture analysis and change detection.

Example 18 provides the one or more non-transitory computer-readable media according to any one of examples 11-17, further including generating a map including locations of the first plurality of patches.

Example 19 provides an apparatus, including a computer processor for executing computer program instructions; and a non-transitory computer-readable memory storing computer program instructions executable by the computer processor to perform operations including receiving a first image frame from an image sensor; downscaling the first image frame to generate a low resolution first image; generating a segmentation map based on the low resolution first image; receiving, at a neural network, the low resolution first image and the segmentation map; determining, based on the segmentation map, indices of a first plurality of patches in the low resolution image; receiving a second image frame from the image sensor; downscaling the second image frame to generate a low resolution second image; generating a second plurality of patches from the second image frame at locations corresponding to the first plurality of patches; performing image signal processing on the second image frame using the low resolution second image and the second plurality of patches to generate an enhanced second image frame; and generating an output image based on the enhanced second image frame, wherein the output image is a full resolution image.

Example 20 provides the apparatus according to example 19, where determining the indices of the first plurality of patches includes identifying a flat region in the low resolution first image; and determining first indices of a first patch for texture analysis in the flat region.

Example 21 provides the apparatus according to example 20, where generating the second plurality of patches includes generating a second patch at second indices of the second image frame corresponding to a portion of the low resolution first image of the first indices of the first patch, and where performing image signal processing on the second image frame includes collecting texture data for the second patch.

Example 22 provides the apparatus according to any one of examples 19-21, where determining the indices of the first plurality of patches includes identifying a region of intensity change in the low resolution first image; and determining first indices of a first patch for change detection in the region of intensity change.

Example 23 provides the apparatus according to example 22, where generating the second plurality of patches includes generating a second patch at second indices of the second image frame corresponding to a portion of the low resolution first image of the first indices of the first patch, and where performing image signal processing on the second image frame includes collecting change data for the second patch.

Example 24 provides the apparatus according to example 23, where performing image signal processing on the second image frame includes collecting change data for a corresponding patch in the first image frame, and identifying changes between the second patch and the corresponding patch.

Example 25 provides the apparatus according to any one of examples 19-24, where the neural network is a first neural network, and where performing image signal processing on the second image frame includes analyzing, at a second neural network, the second plurality of patches for one of texture analysis and change detection.

Example 26 provides the apparatus according to any one of examples 19-25, further including generating a map including locations of the first plurality of patches.

Example 27 provides the computer-implemented method according to examples 1-10, wherein performing image signal processing on the second image frame includes at least one of: adjusting textured areas to enhance texture based, at least in part, on one or more patches of the second plurality of patches, sharpening edges and fine details based, at least in part, on one or more patches of the second plurality of patches, adjusting image contrast to optimize the range between light and dark regions based, at least in part, on one or more patches of the second plurality of patches, and performing color correction to adjust white balance and color fidelity for natural and accurate color representations based, at least in part, on the one or more patches of the second plurality of patches.

Example 28 provides the one or more non-transitory computer-readable media according to any one of examples 11-18, wherein performing image signal processing on the second image frame includes at least one of: adjusting textured areas to enhance texture based, at least in part, on one or more patches of the second plurality of patches, sharpening edges and fine details based, at least in part, on one or more patches of the second plurality of patches, adjusting image contrast to optimize the range between light and dark regions based, at least in part, on one or more patches of the second plurality of patches, and performing color correction to adjust white balance and color fidelity for natural and accurate color representations based, at least in part, on the one or more patches of the second plurality of patches.

Example 29 provides the apparatus according to any one of examples 19-26, wherein performing image signal processing on the second image frame includes at least one of: adjusting textured areas to enhance texture based, at least in part, on one or more patches of the second plurality of patches, sharpening edges and fine details based, at least in part, on one or more patches of the second plurality of patches, adjusting image contrast to optimize the range between light and dark regions based, at least in part, on one or more patches of the second plurality of patches, and performing color correction to adjust white balance and color fidelity for natural and accurate color representations based, at least in part, on the one or more patches of the second plurality of patches.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
receiving a first image frame from an image sensor;
downscaling the first image frame to generate a low resolution first image;
generating a segmentation map based on the low resolution first image;
receiving, at a neural network, the low resolution first image and the segmentation map;
determining, based on the segmentation map, indices of a first plurality of patches in the low resolution image;
receiving a second image frame from the image sensor;
downscaling the second image frame to generate a low resolution second image;
generating a second plurality of patches from the second image frame at image locations corresponding to the indices of the first plurality of patches;
performing image signal processing on the second image frame using the low resolution second image and the second plurality of patches to generate an enhanced second image frame; and
generating an output image based on the enhanced second image frame, wherein the output image is a full resolution image.

2. The computer-implemented method according to claim 1, wherein determining the indices of the first plurality of patches includes:
identifying a flat region in the low resolution first image; and
determining first indices of a first patch for texture analysis in the flat region.

3. The computer-implemented method according to claim 2, wherein generating the second plurality of patches includes generating a second patch at second indices of the second image frame corresponding to a portion of the low resolution first image of the first indices of the first patch, and wherein performing image signal processing on the second image frame includes collecting texture data for the second patch.

4. The computer-implemented method according to claim 1, wherein determining the indices of the first plurality of patches includes:
identifying a region of intensity change in the low resolution first image; and
determining first indices of a first patch for change detection in the region of intensity change.

5. The computer-implemented method according to claim 4, wherein generating the second plurality of patches includes generating a second patch at second indices of the second image frame corresponding to a portion of the low resolution first image of the first indices of the first patch, and wherein performing image signal processing on the second image frame includes collecting change data for the second patch.

6. The computer-implemented method according to claim 5, wherein performing image signal processing on the second image frame includes collecting change data for a corresponding patch in the first image frame, and identifying changes between the second patch and the corresponding patch.

7. The computer-implemented method according to claim 1, wherein the neural network is a first neural network, and wherein performing image signal processing on the second image frame includes analyzing, at a second neural network, the second plurality of patches for one of texture analysis and change detection.

8. The computer-implemented method according to claim 1, further comprising generating a map including locations of the first plurality of patches.

9. One or more non-transitory computer-readable media storing instructions executable to perform operations, the operations comprising:
receiving a first image frame from an image sensor;
downscaling the first image frame to generate a low resolution first image;
generating a segmentation map based on the low resolution first image;
receiving, at a neural network, the low resolution first image and the segmentation map;
determining, based on the segmentation map, indices of a first plurality of patches in the low resolution image;
receiving a second image frame from the image sensor;
downscaling the second image frame to generate a low resolution second image;
generating a second plurality of patches from the second image frame at image locations corresponding to the first plurality of patches;
performing image signal processing on the second image frame using the low resolution second image and the second plurality of patches to generate an enhanced second image frame; and
generating an output image based on the enhanced second image frame, wherein the output image is a full resolution image.

10. The one or more non-transitory computer-readable media according to claim 9, wherein determining the indices of the first plurality of patches includes:
identifying a flat region in the low resolution first image; and
determining first indices of a first patch for texture analysis in the flat region.

11. The one or more non-transitory computer-readable media according to claim 10, wherein generating the second plurality of patches includes generating a second patch at second indices of the second image frame corresponding to a portion of the low resolution first image of the first indices of the first patch, and wherein performing image signal processing on the second image frame includes collecting texture data for the second patch.

12. The one or more non-transitory computer-readable media according to claim 9, wherein determining the indices of the first plurality of patches includes:
identifying a region of intensity change in the low resolution first image; and
determining first indices of a first patch for change detection in the region of intensity change.

13. The one or more non-transitory computer-readable media according to claim 12, wherein generating the second plurality of patches includes generating a second patch at second indices of the second image frame corresponding to a portion of the low resolution first image of the first indices of the first patch, and wherein performing image signal processing on the second image frame includes collecting change data for the second patch.

14. The one or more non-transitory computer-readable media according to claim 13, wherein performing image signal processing on the second image frame includes collecting change data for a corresponding patch in the first image frame, and identifying changes between the second patch and the corresponding patch.

15. The one or more non-transitory computer-readable media according to claim 9, wherein the neural network is a first neural network, and wherein performing image signal processing on the second image frame includes analyzing, at a second neural network, the second plurality of patches for one of texture analysis and change detection.

16. An apparatus, comprising:
a computer processor for executing computer program instructions; and
a non-transitory computer-readable memory storing computer program instructions executable by the computer processor to perform operations comprising:
receiving a first image frame from an image sensor;
downscaling the first image frame to generate a low resolution first image;
generating a segmentation map based on the low resolution first image;
receiving, at a neural network, the low resolution first image and the segmentation map;
determining, based on the segmentation map, indices of a first plurality of patches in the low resolution image;
receiving a second image frame from the image sensor;
downscaling the second image frame to generate a low resolution second image;
generating a second plurality of patches from the second image frame at locations corresponding to the first plurality of patches;
performing image signal processing on the second image frame using the low resolution second image and the second plurality of patches to generate an enhanced second image frame; and
generating an output image based on the enhanced second image frame, wherein the output image is a full resolution image.

17. The apparatus according to claim 16, wherein determining the indices of the first plurality of patches includes:
identifying a flat region in the low resolution first image; and
determining first indices of a first patch for texture analysis in the flat region.

18. The apparatus according to claim 17, wherein generating the second plurality of patches includes generating a second patch at second indices of the second image frame corresponding to a portion of the low resolution first image of the first indices of the first patch, and wherein performing image signal processing on the second image frame includes collecting texture data for the second patch.

19. The apparatus according to claim 16, wherein determining the indices of the first plurality of patches includes:
identifying a region of intensity change in the low resolution first image; and
determining first indices of a first patch for change detection in the region of intensity change.

20. The apparatus according to claim 19, wherein generating the second plurality of patches includes generating a second patch at second indices of the second image frame corresponding to a portion of the low resolution first image of the first indices of the first patch, and wherein performing image signal processing on the second image frame includes collecting change data for the second patch.
